(19) United States
(12) Patent Application Publication
(10) Pub. No.: US 2011/0227338 A1
(43) Pub. Date: Sep. 22, 2011

(54) SEALED PIPE JOINT

(76) Inventors: Jack Pollack, Houston, TX (US); David C. Riggs, Coppell, TX (US)

(21) Appl. No.: 13/013,739

(22) Filed: Jan. 25, 2011

Related U.S. Application Data
(60) Provisional application No. 61/316,371, filed on Mar. 22, 2010.

(51) Int. Cl. F16L 15/04; F16L 15/06; F16L 15/08; B23P 17/04

(52) U.S. Cl. 285/355; 285/390; 29/428

(57) ABSTRACT

In a pipe joint where two pipe sections (14, 16) have threadably engaged end portions (17, 18), joint ends (32, 34) are substantially sealed to each other by a sealing surface (40, 50) on one pipe section that substantially abuts a sealing surface (42, 52) on the other pipe section. In one joint, a ring-shaped cutout (121, FIG. 7) is formed in a first pipe section and a ring-shaped spacer (120) is located in the cutout. The spacer is chosen from several that have slightly different lengths so the spacer end contacts the corresponding sealing surface (130). In a pipe string used to carry corrosive fluid, the inner surface (44) of adjacent pipe sections is covered with a corrosion resistant coating (70, 72). Where the sealing surface is connected to a rounded corner (82, 84), the coating extends to and along the sealing surfaces (40, 42). Where there are sharp corners (80) at the intersection of the inside surface (40) with the sealing surface (40B, 42B), the coating does not extend along the sealing surfaces.

### CROSS-REFERENCE

Applicant claims priority from U.S. provisional patent application Ser. No. 61/316,371 filed 22 Mar. 2010.

### BACKGROUND OF THE INVENTION

Pipe strings consisting of many pipe sections connected in tandem, are widely used in the sea to transfer crude oil and other hydrocarbons between the sea floor and a floating body, or between floating bodies. One common type of pipe string includes many steel pipe sections, each of a length such as 30 meters, that are connected together by threaded end portions lying at opposite ends of each pipe. Applicant notes that one type of thread is a helical thread, and another type includes axially-spaced circular threads. Each end of a pair of adjacent pipe sections is preferably sealed to the other pipe section by a sealing surface on the end of one pipe section that presses against a sealing surface on the end of the other pipe section as the pipe section are threaded together. Previously, the opposite ends of a pipe sections could not both be tightly sealed, unless very high precision were used in the manufacture which results in prohibitive cost.

Many fluids to be carried by the pipe string are highly corrosive. A protective coating or cladding can be applied to the inside surface of the pipe sections, and to adjacent pipe surfaces. The cost of applying such coating can be minimized by minimizing the area to be coated, especially areas that include sharp angles.

A pipe joint that includes a pipe with threaded portions and with sealing surfaces at the ends, often includes tongue and groove joints that lie beside sealing surfaces. There is occasional fracture of the steel pipe end at a side of the groove.

### SUMMARY OF THE INVENTION

In accordance with one embodiment of the present invention, a corrosion resistant pipe string is provided with threaded pipe joints that are constructed to substantially seal to one another. To assure that the sealing surfaces at opposite ends of a pipe section abut corresponding sealing surfaces, applicant shortens one of the abutments to create a cutout. Applicant also provides a ring-shaped spacer that lies in the cutout. Several spacers are available of very slightly different lengths, and during pipe string assembly a spacer is chosen that just fills the cutout.

To protect the pipe sections against corrosion by corrosive fluid, the inside of each pipe section is coated, as by a cladding of corrosion resistant material. Where there is a rounded corner between the inside of the pipe and a sealing surface, the coating is extended around the corner and along the sealing surfaces, but no further. To avoid extending the coating around a rounded corner, the sealing surfaces each can be provided with a sharp (small radius of curvature) corner so the two corners abut one another.

The pipe ends include tongue and groove connections. To avoid one of the pipes fracturing at the outer side of the groove, the groove bottom is provided with a small radius of curvature. This allows the outer side of the groove to be provided with a large radius of curvature so that stresses are better resisted.

To prevent the threaded end portions of the pipe sections from turning to loosen the threaded connection, at least one pipe thread is knurled to generate small ridges that resist loosening.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a sectional view of a joint potion of a pipe string, showing the threadably connected adjacent ends of two pipe sections and showing the sealing surfaces at the opposite ends of the threads.

FIG. 2 is a sectional view of area 2-2 of FIG. 1.

FIG. 3 is a sectional view of area 3-3 of FIG. 1.

FIG. 4 is a sectional view similar to that of FIG. 3, but with a corrosion-resistant cladding on the entire straight inside portion of the pipes.

FIG. 5 is sectional view similar to that of FIG. 4, but with a corrosion-resistant cladding on only the inside portion that lies adjacent to the sealing surfaces.

FIG. 6 is a sectional view of only one side of the pipe joint of a pipe string similar to that of FIG. 1, but with a spacer lying in a cutout.

FIG. 7 is a sectional view of the cutout and spacer region of the joint portion of FIG. 6.

FIG. 8 is a sectional view similar to that of FIG. 2, but with a tongue and groove connection constructed with a gradual curvature at one side of the groove.

FIG. 9 is a view similar to that of FIG. 3, showing the gradual curvature at one side of the groove.

FIG. 10 is a sectional view of a pair of thread lengths of the threadably joined end portions of the pipe sections of FIG. 1, showing knurling.

FIG. 11 is an isometric view of a portion of one of the thread lengths of FIG. 10.

### DESCRIPTION OF THE PREFERRED EMBODIMENTS

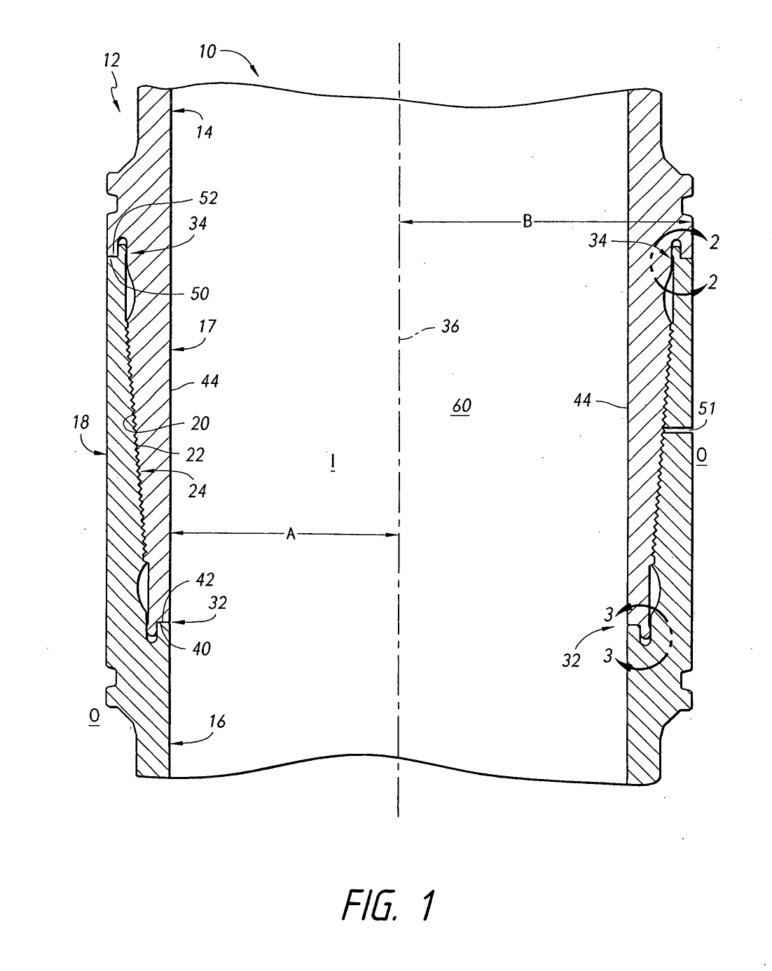

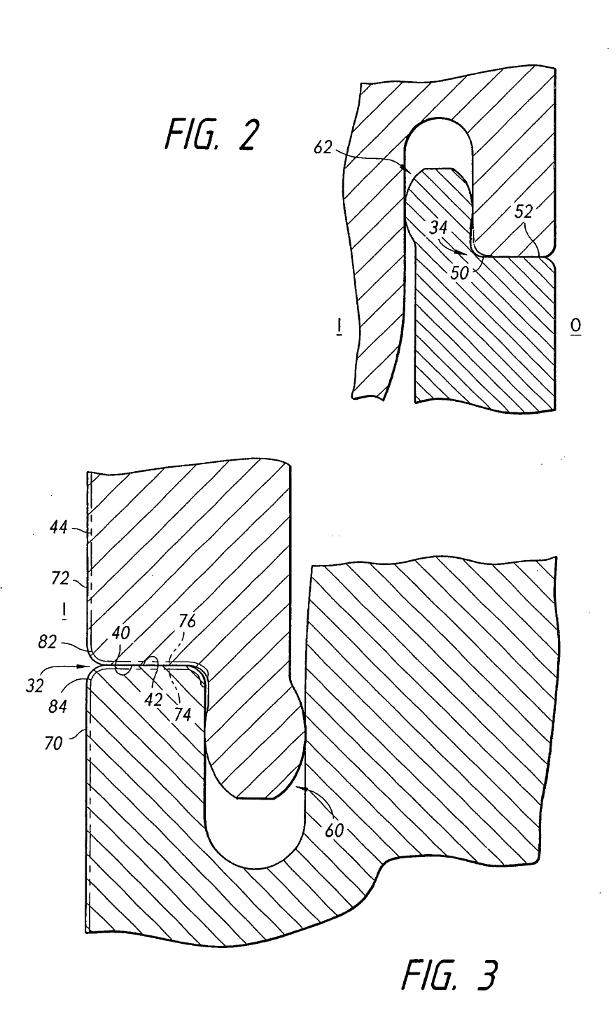

FIG. 1 shows a pipeline, or pipe string 10 that includes many steel pipe sections, each of a length such as 30 meters, which are threadably connected in tandem. Applicant notes that one type of threaded joint includes a helical thread, and another type includes axially-spaced (with respect to the pipeline axis) circular threads that lie on an imaginary cone. FIG. 1 shows a pipe joint 12 where adjacent end portions 17, 18 of two pipe sections 14, 16 are connected. The joint includes threads 20 22 on the two pipe sections that form a threaded connection 24. The threads are tightened to press the two pipe ends close together at sealing surfaces 40, 42, 50, 52 that lie at axially (A) opposite joint ends 33, 34. To minimize thread chafing during a threadable connection applicant forms a port 51 in the radially (with respect to axis 36) outer pipe end 18. The joint can be pressurized by a fluid (liquid or gas) directed through the port 51, which compresses radially inner pipe end 17 and which expands radially outer pipe end 18, thereby easing the threads 20, 22 over one another.

Joint end 32 has upper and lower abutments, or sealing surfaces 40, 42 that both lie at the inside I of the pipeline. Joint end 34, which is shown located at the upper end of the joint 12, has radially outer (with respect to the axis 36) sealing surfaces.

Of the two joint ends 32, 34, usually only one, which is the upper and outer abutment location 34 has its abutment faces 50, 52 forcefully abutting one another when the threads are fully tightened. It would require extremely close dimensional tolerances (e.g. less than about 0.02 mm, or 0.001 inch) to assure forceful abutment of the abutment surfaces at both joint end 32, 34. To manufacture the pipe section ends to these tolerances would be difficult and costly.

Applicant causes the inner sealing surfaces 40, 42 and the outer sealing surfaces 50, 52 to forcefully abut one another and form a fluid seal thereat that prevents the ingress and egress of fluids. This also preloads the connector threads to thereby reduce fatigue stresses and stabilize metal-to-metal seal movement at the pipe joint ends 32, 34 shown in FIG. 7.

The inside I (FIG. 1) of the pipe joint is exposed to fluids 60 lying in the pipe, which may include corrosive chemicals when the pipeline is used to carry a mixture of hydrocarbons and corrosive components such as is often found in crude oil. The outside O of the pipe joint is exposed to seawater or atmospheric conditions.

In recent years, offshore oil production has been conducted in ever deeper waters, with the present maximum depth being about 7000 to 10,000 feet. In such depths, steel pipelines connected to floating production units are usually employed to transport well fluids from the seabed to the sea surface. The high seawater pressure at large depths requires large pipe wall thickness to resist collapse, although the pipe inside diameter must be large enough for economic hydrocarbon production rates. This leads to relatively stiff pipes and high bending stresses, especially where a pipeline hanging in a catenary shape makes contact with the seabed. This bending is repetitive as it is the result of the heave of the surface vessel which is constantly being excited by surface waves. This repetitive bending leads to pipe fatigue. This fatigue can be accelerated by the presence of H₂S, CO₂ or other chemicals in the well fluids flowing through these pipes, which can lead to a very limited pipe fatigue life. To minimize this chemical effect, Applicant prefers to apply a CRA (corrosion resistant alloy) cladding (a type of coating), shown in phantom lines at 70, 72 in FIG. 3, on the inside surface 44 of the pipeline, with portions 74, 76 of the cladding lying on the inside sealing surfaces 40, 42. Since the inside joint end 32 is closed during use, the cladding portions 74, 76 at the abutting surfaces need not be thicker than on the rest of the inside of the pipe. The corners 82, 84 between the radially inside surfaces 44 and the sealing surfaces 40, 42 have a large radius of curvature of at least 0.05 inch so the cladding extends over them.

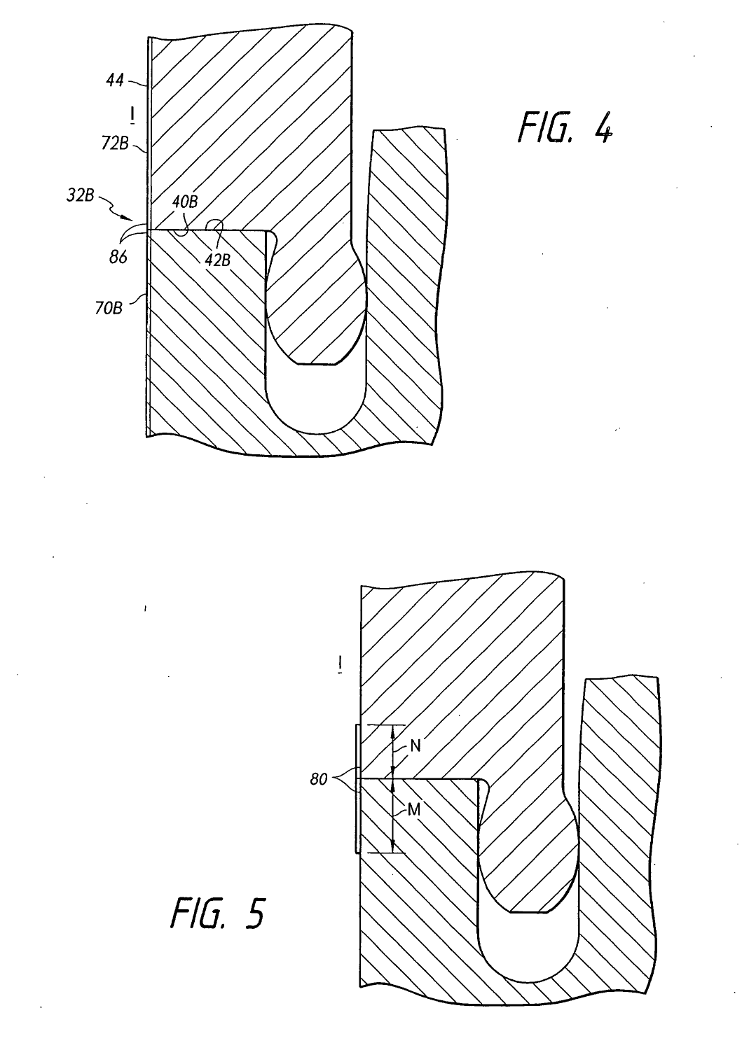

FIG. 4 shows one alternative construction of a joint end 32B, where CRA cladding portions 70B, 72B have been applied on the inside surface of the pipeline, but not on the sealing surfaces 40B, 42B. The corners 86 have a small radius of curvature of less than 0.05 inch so the cladding portions lie facewise adjacent to each other and do not extend around the corners. FIG. 5 shows another alternative, where the cladding extends only a limited distance M, N on either side of the inside 80 of the abutment, where M and N are no more than half each pipe section length.

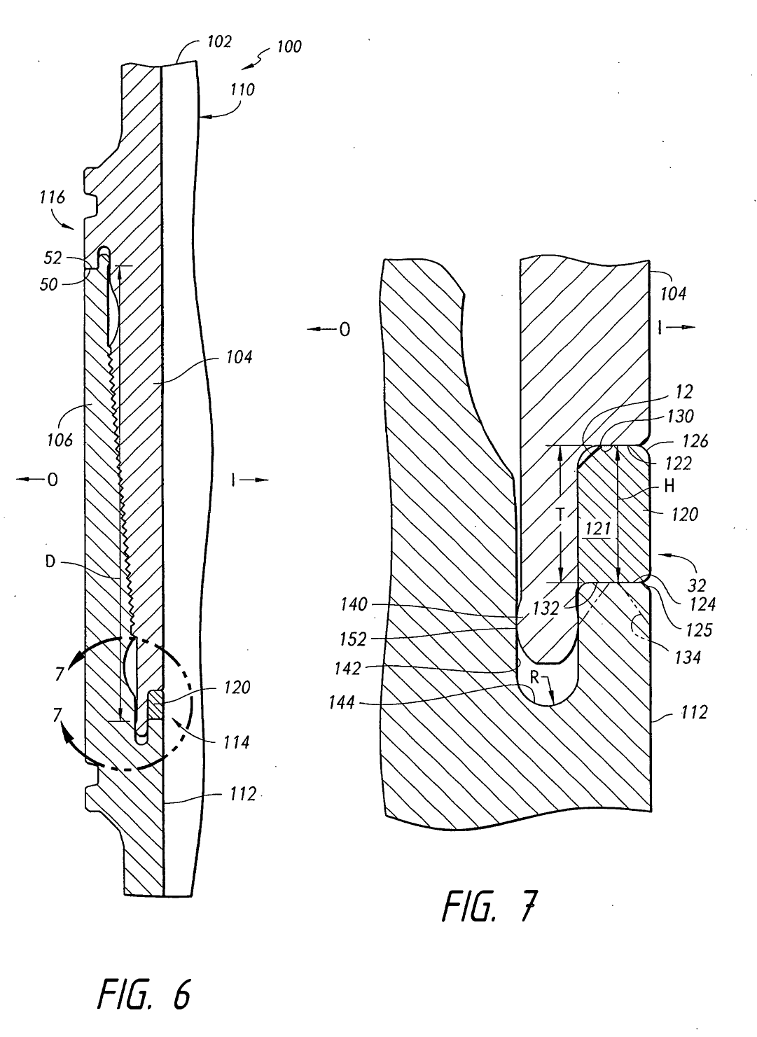

FIG. 6 shows another pipe joint 100 along a pipeline 102 in which adjacent ends 104, 106 of two pipe sections 110, 112 are threadably connected, which provides sealing at axially-spaced inside and outside locations, or joint ends 114, 116 at the bottom and the top of the pipe joint. The sealing is made by parts that are precisely spaced along the pipeline axis, but which can be made with high precision at moderate cost. At the upper and outside seal location 116, sealing surfaces 50, 52 of the two pipe sections directly abut one another in the same manner as in FIG. 1. However, at the lower and inside seal location 114, applicant provides a spacer 120 (FIG. 7) that lies in a gap 121 that results in a short end (125). The spacer abuts both a shoulder 122 on the upper pipe section end and a shoulder 124 on the lower pipe section end.

The spacer 120, which is in the form of a ring, is preferably formed of metal in order to withstand the high compressive forces applied when the two pipe sections are tightly threaded together. Applicant may fabricates multiple spacers with slightly different heights, or axial thicknesses T. A storage container containing many spacers of slightly different thicknesses H are provided near the location where the pipes are to be joined. In one example, for steel pipes of 12 inches diameter (at the inside), multiple spacers are provided whose thicknesses vary in increments of 0.02 mm (0.001 inch). The lengths of the pipe section ends are preferably constructed with precision, with an accumulated tolerance and therefore variation in gap height H such as 0.2 mm (0.1 inch). Recent studies show that several spacers may not have to be taken into the field, and therefore the spacer ring may be pressed into place before equipment is taken into the field.

Before assembling pipe sections, applicant calculates and\or measures the size of the gap H to be filled by the spacer, for two pipe ends that are to be joined. This may be done with a laser range finder or a more conventional caliper. Applicant measures the distance D (FIG. 6) between the two sealing surfaces of each pipe joint end. The spacer height H is chosen to equal the difference. A spacer of the proper thickness is selected to fill the gap when those two pipe section ends are to be joined. The pipe sections and spacer are preferably numbered and kept together so that the particular spacer can be used when those two pipe section ends are threadably joined. It would be possible to join two pipe sections and measure the gap before disassembly to insert the spacer. However, such a process consumes time and idles high cost workers and equipment which would be most efficiently used to join pipe sections.

The spacer 120 (FIG. 7) is shown as having a rectangular cross section with slightly rounded corners 126 and with one beveled corner 128 that lies at an inside corner of a pipe section end. The sealing, or abutting faces 130, 132 of the spacer are shown as flat. However, it is possible to form a sealing face with one or more ridges, as shown at 134, to enable greater axial compression of the spacer at a given compression force. It also is possible to use a material other than steel, such as one that is more easily compressed, if a suitable material is found.

Applicant prefers to place the spacer 120 at the inside of the pipeline, where the spacer cannot be dislodged if the pipeline is hit. It would also be possible to move the spacer 120 to the outer abutment surface 34 in which case the inner abutment could be machined to be without a ring spacer 120. It would also be possible to simplify and also rectify the machining of the connector in such a way that one uses spacers 120 at both joint ends 32 and 34.

The pipeline shown in the figures has a diameter (outside) of 20 inches and a wall thickness of one inch (along much of its length). The spacer 120 has a radial width of 0.33 inch and an axial height of 0.75 inch. The pipes and spacer are each fabricated of steel.

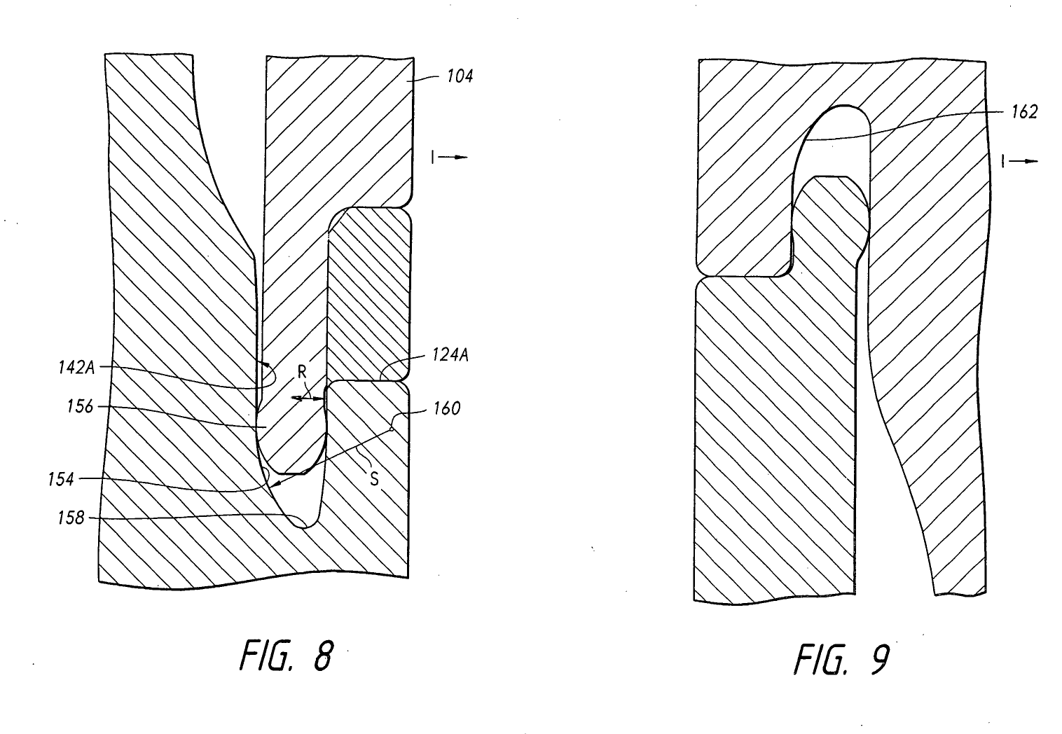

In the tongue and groove joint portion of FIG. 7, one pipe end portion 104 forms a tongue 140 that is received in an interference fit in a groove 142 of the other pipe end portion 112. In FIG. 7 the groove end 144 has about the same radius of curvature as the tongue end, and the radius R is half the distance 2R across the groove. Applicant has found that the walls of the groove 142 sometimes would crack in the outer curved part of the groove due to repetitive bending stress. Applicant found that by forming the outside 154 (FIG. 8) of the groove at 142A that lies adjacent to sealing surface 124A with a moderate radius of curvature S instead of a straight side, applicant avoided such cracking. The groove side 154 has a radius of curvature S at least 50% greater than the distance R which is half the groove width, but less than 10R. In FIG. 8 the radius of curvature is centered at 160 and is four times the distance R. The bottom 158 of the groove has a small radius of curvature that is less than half the width 2R, but lies away from the tongue. In making the wide outer curvature in groove 142 (FIG. 7) the groove becomes asymmetric and ends up with a curvature at the inside of the connector, as shown in FIGS. 8 and 9. The upper groove 162 shown in FIG. 9, is similarly curved.

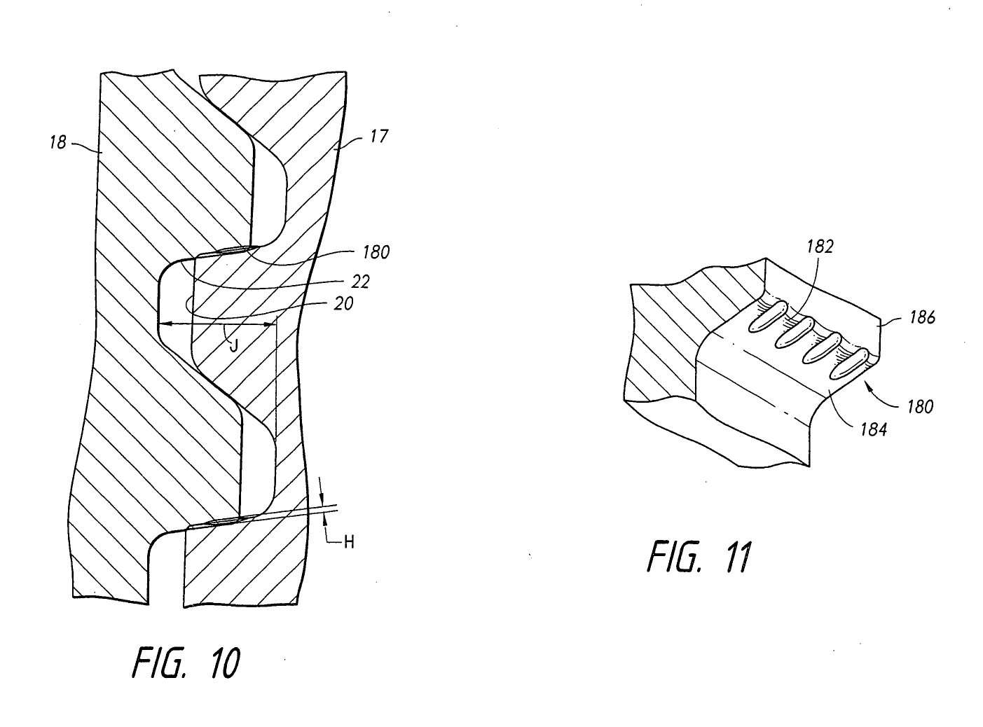

FIG. 1 shows that the adjacent pipe end portions 17, 18 are connected by concentric parallel threads. Steps should be taken to be sure that after the threads 20, 22 are threadably connected, they do not slip by torque applied to one of the pipe end portions relative to the other. Applicant prefers to do this by knurling the threads. FIGS. 10 and 11 show knurling 180. In knurling, small grooves are formed by pressing a knurling tool against a location on the threads. The pressure of knurling displaces the material that forms the threads to form depressions separated by slight projections 182. The displaced material prevents the threads from turning relative to each other unless a large torque is applied. Applicant provides knurling at one side of the threads in a thread groove wall 184 rather than in the cylindrical wall 186, of a height H of 0.004 inch and width of 0.030 inch. Applicant could resist relative turning by roughening surfaces that turn relative to each other and that are not part of the threads, as by shot peening. However, threads are precisely cut surfaces, and the knurling formed in them is more precise than roughening of a smooth (non-threaded) surfaces.

In the case of axially spaced concentric threads, there can be cases where the torsional resistance of the knurling 180 may not be sufficient to keep the connector from slipping. Applicant prefers to make the surfaces of the tongue 140 (FIG. 7) and groove 142 of materials that will allow slippage without causing damage to these surfaces. This can be aided with the use of anti galling coatings or lubricants or by the use of different materials of these contacting surfaces. In the event these surfaces cannot be kept from damage by slippage, applicant inserts a key into grooves machined into the threads of connector halves to prevent slippage.

Thus, the invention provides pipe joints for connecting the threaded ends of a pair of pipe sections, which minimizes corrosion resulting from corrosive fluids, which enables an abutment at each end of the joint to abut a sealing surface at moderate cost, and which avoids cracking of a pipe at a groove. Corrosion is avoided by coating the inside end of each pipe section where it lies adjacent to an inside end of the other pipe section. Where there is a large radius of curvature (of more than 0.05 inch) at the adjacent corners of the two pipe inside ends, the corners and facing surfaces are coated, preferably by a corrosion-resistant cladding. Where the inside ends of the two pipes abut each other at sharp corners (radius of curvature less than 0.01 inch), no coating is applied beyond the corners to lie on the facing surfaces. Sealing surfaces at opposite ends of each pipe can be made to abut one another by making one pipe end short and placing a spacer at that end, with the spacer chosen to precisely fill the gap to the adjacent sealing surface. Where a tongue and groove joint connects the pipe ends, cracking at one side wall of the groove is avoided by making a portion of that groove wall with a large radius of curvature.

Although particular embodiments of the invention have been described and illustrated herein, it is recognized that modifications and variations may readily occur to those skilled in the art, and consequently, it is intended that the claims be interpreted to cover such modifications and equivalents.

1. A pipe string (10) that includes a pipe joint (12) that connects first and second threaded ends of a pair of pipe sections (14, 16), where said pipe joint has first and second joint ends (32, 34), said joint ends including a first joint end (34) having facewise adjacent first sealing surfaces (50, 52), wherein:
a second (32) of said joint ends has a ring-shaped cutout (121) lying adjacent to a second sealing surface (130), so said second joint end has a short second end (125) that is spaced from said second sealing surface (130); and including
a ring shaped spacer (120) that lies between and abuts said short second end (125) and said second sealing surface (130).

2. The pipe string described in claim 1 including:
a plurality of ring-shaped spacers (120) that each has a height (H) for bridging said cutout (121), said plurality of spacers differing in height (H) from each of a plurality of other spacers, by a height difference on the order of magnitude of 0.001 inch.

3. The pipe string described in claim 1 wherein:
said pipe joint has radially inner I and outer O sides;
said cutout and said spacer both lie at said inner side.

4. The pipe string described in claim 1 wherein:
one of said sealing surface (134) is tapered in radial width to have a smallest width where it abuts another (134) of said sealing surfaces.

5. A method for installing a pipe string by threadably connecting first and second threaded end portions (32, 34) of pairs of adjacent pipe sections to form a pipe joint (12) with opposite joint ends (32, 34), with the threads tightened so sealing surfaces (40, 42 and 50, 52) of said first and second pipe section ends abut each other, including:
constructing said first joint end with a cutout (121) at a first end part, and installing a ring-shaped spacer (120) in said cutout wherein said spacer is of a proper axial length (T) to allow sealing surface (40, 42, 50, 52) at both of said joint ends to abut each other;
said step of installing said spacer includes providing a plurality of spacers of slightly different lengths, and selecting and installing a spacer of the proper axial length to allow the pair of sealing surfaces at each of said joint ends to abut one another.

6. A pipe string that carries corrosive fluid, including first and second pipe sections that have threaded end portions that are threadably engaged and that form opposite joint ends (32, 34) where sealing surfaces (40, 42, 50, 52) of the two pipe sections lie facewise adjacent to each other, wherein a first pair (40, 42) of adjacent sealing surfaces lies adjacent to the inside (I) of the pipe section, and wherein:
the inside surface (44) of each pipe section at each joint end, contains a coating (70, 72) of a protective material, that extends along the inside surface of the pipe section at at least said first pair (40, 42) of adjacent sealing surfaces, with the outside of each pipe section being free of said coating.

7. The pipe string described in claim 6, wherein:
at said first joint end, said first pipe section has a corner (82, 84) formed by an axially-extending inside surface (70, 72) of the pipe and an adjacent sealing surface (74, 76), said corner being rounded at a radius of curvature of at least 0.1 inch, and said coating extends around said corner and along said sealing surface.

8. The pipe string described in claim 6 wherein:
at said first joint end said first pipe section has a corner (80) formed by an axially-extending inside surface (70B, 72B) of the pipe and an adjacent sealing surface (40B, 42B), said corner having a radius of curvature of less than 0.02 inch, and said coating terminates at said corner.

9. The pipe string described in claim 6, wherein:
one of said pipe section end portion (17) forms the inside surface (44) of the pipe joint and the other pipe section end portion (18) forms the outside surface;
said other pipe section end portion having a through hole (51) through which fluid can be pumped to facilitate the threaded assembly and disassembly of the pipe section end portions.

10. A pipe string that includes first and second pipe sections that have adjacent first ends centered on an axis, where said first pipe section has a sealing surface (124A) and has an axially-extending groove (142A), and where said second pipe section has an axially extending tongue (156) with an enlarged and rounded tongue end that lies in said groove, wherein:
said groove has radially opposite sides that are spaced along a radial direction, and said groove has an axial end that forms a groove bottom (158);
said groove has a radial width (2R), and at least one of said groove sides has a large radius of curvature (160) that is greater than said radial width (2R) along a region above said groove bottom as viewed perpendicular to said radial direction.

11. The pipe string described in claim 10 wherein:
the radius of curvature of said groove bottom is no more than half said radial width.

12. A pipe string that includes first and second metal pipe sections with threaded ends that are threadably connected, wherein:
at least one of said threaded ends is knurled along its threads to form alternate depressions from which metal has been displaced and projections into which metal has been displaced along a portion of the thread.

13. The pipe string described in claim 12 wherein:
said threads have thread groove walls (184) and have cylindrical surfaces (186) connecting the thread grooves, and said knurling lies in said thread groove wall (184).

14. A method for facilitating the tightening of a threadable connection between first and second threaded ends (17, 18) of a pair of pipe sections wherein said first threaded end lies radially inside said second threaded end, comprising:
forming a hole in said second threaded end that leads to the intersection between said threaded ends, and forcing a fluid under pressure through said hole, to push apart said threaded ends while turning one of said threaded ends.

15. The pipe string described in claim 1 wherein:
said threaded ends of said pair of pipe sections have threads (20, 22) that are threaded together, with said threads (20, 22) lying between said first joint end (34) that forms said first sealing surfaces (50, 52) and said second joint end (32), whereby to initially hold said threads under tension.

16. The pipe string described in claim 1 wherein:
said pipe sections and said spacer are each formed of steel.

17. The pipe string described in claim 10 wherein:
said tongue (156) of said second pipe section, has a tongue end that is spaced from an end (158) of said axially extending groove (142A), so the tongue does not bottom, or land, on the bottom of the groove.
